(19) United States
(12) Patent Application Publication
(10) Pub. No.: US 2025/0032998 A1
(43) Pub. Date: Jan. 30, 2025

(54) PRINTED POROUS STRUCTURE, METHOD AND APPARATUS FOR PRODUCTION THEREOF

(71) Applicant: Cytiva Sweden AB, Uppsala (SE)

(72) Inventors: Martina Lorenzetti, Buccinasco (IT); Rodrigo Hernan-Dez Vera, Uppsala (SE); Johan Alriksson, Uppsala (SE)

(21) Appl. No.: 18/834,983

(22) PCT Filed: Feb. 2, 2023
(86) PCT No.: PCT/EP2023/052614

§ 371 Date: Jul. 31, 2024

(30) Foreign Application Priority Data
Feb. 7, 2022 (GB) 2201536.6

(51) Int. Cl. B01D 69/10; B01D 69/02; B01D 69/12; B29C 64/124; B29C 64/30; B29L 31/14; B33Y 10/00; B33Y 40/20; B33Y 80/00

(52) U.S. Cl. CPC B01D 69/107; B01D 69/02; B01D 69/12; B29C 64/30; B33Y 10/00; B33Y 40/20; B33Y 80/00; B01D 2325/0283; B01D 2325/02834; B01D 2325/04; B29C 64/124; B29L 2031/14

(57) ABSTRACT

A printed porous structure (500) fabricated using a multi-step absorption, MSA, process, said printed porous structure (500) comprising a support layer (520) that supports a filtration membrane (510), wherein said support layer (520) and said filtration membrane (510) are integrally formed.

### FIELD

The present invention relates to printing of porous structures. More specifically, the present invention relates to printing of three dimensional (3D) structures.

### BACKGROUND

The printing of certain types of porous structure is known. See, for example, WO 2020/089421 A1 which is hereby incorporated herein by reference in its entirety. Such porous structures may, for example, be used as filter components or the like.

Whilst filter components produced by the technique of WO 2020/089421 A1 are a marked improvement on those previously manufactured, nevertheless improved techniques for manufacturing complex but accurate porous structures are still desired in the art. For example, it is desirable to improve production speed, reduce costs and to have a greater choice of finished materials, structures, etc.

### SUMMARY

Hence various aspects and embodiments of the present invention, as are defined by the appended claims, are provided.

### BRIEF DESCRIPTION OF FIGURES

FIG. 1 shows manufacturing equipment for the printing of a porous structure in accordance with various embodiments of the present invention;

FIG. 2 shows further manufacturing equipment for the printing of a porous structure in accordance with various embodiments of the present invention;

FIGS. 3a to 3c show a manufacturing technique for printing of a porous structure in accordance with various embodiments of the present invention;

FIG. 4 shows a variant of the manufacturing technique shown in FIGS. 3a to 3c;

FIG. 5 shows a printed porous structure in accordance with an embodiment of the present invention;

FIG. 6 shows a cross sectional view of a printed porous structure fabricated using a multi-step absorption (MSA) process in accordance with an embodiment of the invention;

FIG. 7 shows a plan view of the embodiment of FIG. 6;

FIG. 8 shows a top and back side view of a PPS made in accordance with a prior art MSA technique;

FIG. 9 shows a back side view of a PPS made in accordance with an embodiment of the invention at two different magnifications; and

FIGS. 10a and 10b show an ideal gyroid structure and a gyroid structure manufactured using a conventional MSA process.

### DETAILED DESCRIPTION

Various embodiments relating to the present invention will now be described by way of example only.

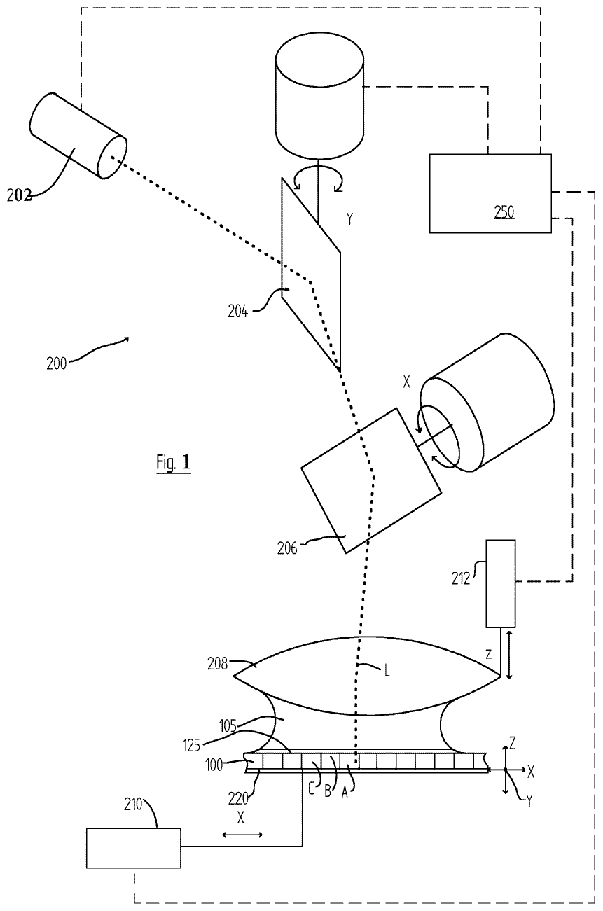

FIG. 1 shows manufacturing equipment 200 for the printing of a porous structure (PPS) in accordance with various embodiments of the present invention.

A photon source 202 in the manufacturing equipment 200 is oriented to propagate a beam of photons L toward two galvanic reflective mirrors 204 and 206 each operable under the influence of a controller 250. The photon source 202 may comprise one or more of: a continuous beam laser, a pulsed beam laser, a light emitting diode (LED), a lamp, a discharge tube and a photon emitter, etc. The photon source(s) 202 may provide coherent photons/beams, partially coherent photons/beams, super-luminescent photons/beams and/or incoherent photons/beams. Such photons/beams may be continuous wave and/or pulsed. The photons provided may include one or more of: infrared, near-infrared, visible and/or ultraviolet photons, etc. Furthermore, the photons may be of substantially the same wavelength. They may also be of different wavelengths.

An adjustable objective lens or lenses 208, again under the influence of the controller 250 is used to focus the beam L to an exact polymerisation point P in a bath 100, for polymerisation of a photo-activatable composition that is provided therein. The photo-activatable composition may be a flowable photo-activatable composition. Photonic activation of the photo-activatable composition by way of a multi-step absorption (MSA) process causes polymerisation therein and is then used to define a printed porous structure that may be, for example, built up layer-by-layer.

Controlled movements of the mirrors 204 and 206 can provide rapid repositioning of a focal point P and a series of polymerised bits 114 may thus be written in the region A shown. Layers of bits can be made by adjustments in the Z height of the lens 208 using a linear actuator 212 under the control of the controller 250. The bath 100 may also be repositioned in the X axis using a further linear actuator 210, and in the Y axis by a similar arrangement not shown, in each case the actuators are under the influence of the controller 250 so that the next regions B and C etc can be polymerised in the same manner by the rapid mirror movements mentioned, before the next region is selected. For better accuracy, the space between the objective 208 and a transmissive layer 125 (e.g. glass) above the bath 100 may be filled with photon transmissive material 105 (such as oil, for example), so that the path of the photons L is largely made through materials having about the same refractive index.

In order to mitigate heat build-up, the photon beam L may also be moved by more than the width between adjacent pores (i.e. the pore pitch). Support 22 may also be separately illuminated (e.g. from underneath) in order to provide at least one photon in a multi-step absorption (MSA) process.

Various polymerisation methods may be used. For example, an MSA process using one or more of: a multi-step, preferably a two-step absorption (TSA) method, an optically enabled method and/or projection-based manufacturing method may be used. In various embodiments, that may be implemented by the controller 250, one or more of: “Two-step absorption instead of two-photon absorption in 3D nanoprinting”, Vincent Hahn et al., Nature Photonics, Vol. 15, December 2021, pp. 932-938, and “Emerging micro-additive manufacturing technologies enabled by novel optical methods”, Wei Lin et al., Photonics Research, Vol. 8, No. 12, December 2020, pp. 1827-1842 techniques are used. The contents of both of these documents are furthermore fully incorporated herein by reference in their entirety.

Other polymerisation methods may alternatively, or additionally, be used. These may include one or more of: a multi-beam, interferometric, projection-based and/or holographic technique, etc. to photonically activate the photo-activatable composition. In addition to, or alternatively to, polymerisation methods materials provided with dissolvable particles (e.g. nano particles) therein may be used to create porous structures and/or wall structures that function as at least part of a porous structure (PPS).

Irrespective of which method of polymerisation is used, successive layering of polymerised material may lead to reduced transparency and diffraction issues. To mitigate those issues, manufacturing equipment 200 may further optionally take advantage of modelling of the exact underlying 3D structure by evaluating and optimizing the dose, angle etc. of the localized photon and energy application to account for non-uniformity in the structure, diffraction patterns etc.

Various printed porous structures (PPS's) may thus be fabricated using a multi-step absorption (MSA) process in the manufacturing equipment 200. Example, of such PPS's include at least one of: a filter, a sieve, a mesh, a membrane, a scaffold, a frame, a lattice and/or a network. Such PPS's may include, for example, a woodpile, diamond lattice, body centred cubic (BCC) and/or a gyroid structure, optionally with a single focus, two foci, and/or three foci, etc. Optionally, fabrication of the PPS's may also further include removing of any unpolymerized composition and/or embedded particles to leave open pores in the printed porous structure (e.g. by vacuum aspiration, solvent dissolution etc.).

In various embodiments, the printed porous structure may comprise substantially similar sized pores therein. The pores therein may have a size of about: 15 μm, 10 μm, 5 μm, 3 μm, 1 μm, 500 nm and/or 100 nm and any intermediate sizes therein. The pore-pore distances (pitch) may be about 10 μm or less.

Various dimension printed porous structures can also be produced, depending on the desired end use application. For example, PPS's having a surface diameter (Ø) of about 13 mm or about 25 mm or less may be provided. A processed area of at least about 0.5 mm² and up to at least about: 1 mm², 10 mm², 1 cm² or 4-5 cm² may be provided. A thickness (z) of: about 5, 10 or 20 μm; at least about 30 μm; at least about 50 μm or at least about 100 μm may also be provided.

Further PPS's comprising at least one region that is substantially devoid of any pores can also be manufactured (e.g. so as to provide a reinforced ring-like support). Additionally, or alternatively, a filter arrangement comprising the printed porous structure (PPS) of any preceding claim and a holder therefor can be produced. Such a holder may optionally be integrally formed with said PPS.

Numerous types of material(s) may also be used to manufacture a PPS. For example, comprising one or more/multi or hybrid/composite of, but not limited to: polyimide, polyethylene, polycarbonate, polypropylene, acrylates, methacrylates, urethanes, PEG (poly-ethylene glycol)-based, PLA (poly-lactic acid)-based, protein-based (e.g. albumin, collagen, fibrinogen) and/or thiol-ene materials, optionally in the form of low-viscosity fluids, high-viscosity fluids or solids. Such material(s) may also be admixed to at least one photo-initiator, optionally including water-soluble and possible doping materials, such as metals, ceramics, nanoparticles or nanotubes, hydrogels and/or shape memory polymers.

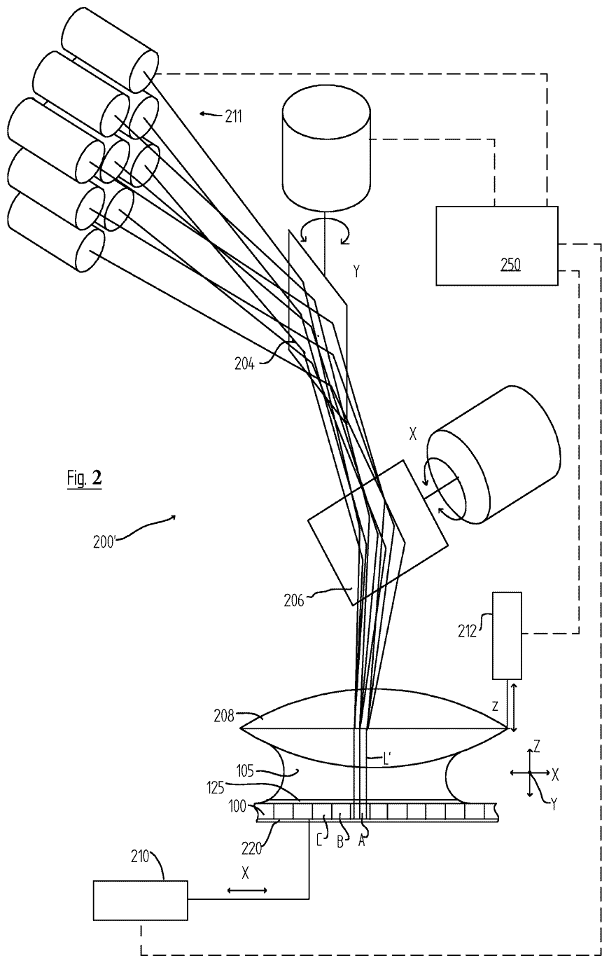

FIG. 2 shows further manufacturing equipment 200′ for the printing of a porous structure in accordance with various embodiments of the present invention.

Whilst the manufacturing equipment 200 of FIG. 1 can provide adequately fast PPS production, faster production may be desirable, and so the use of the multiple photon beams L as shown in FIG. 2 is provided. Although multiple photon sources 211 are provided, multiple photon beams could be produced by splitting one or more photon beams into numerous beams, e.g. using plural beam splitters. The latter approach is less costly, but requires more beam alignment, and so multiple photon sources 211 might be preferred.

The manufacturing equipment 200′ shown in FIG. 2 operates in a similar manner to that described above with reference to FIG. 1, except that plural photon sources 211 are grouped together with their output beams formed into a convergent pattern (in this case nine photon sources are arranged in a three by three, two-dimensional pattern). The photon beams propagate toward the bath of polymer composition 100 as explained above and can be moved stepwise to form the polymerised bits as detailed above.

The photon beams L′ may be spaced more than one pore pitch apart (e.g. so as to mitigate heat build-up). Thus, for example if the beams L′ are spaced by X pitches and moved by X-1 pitches stepwise then, excluding edge pores, the remaining pores can be formed with less heat build-up than by moving just one pitch at a time.

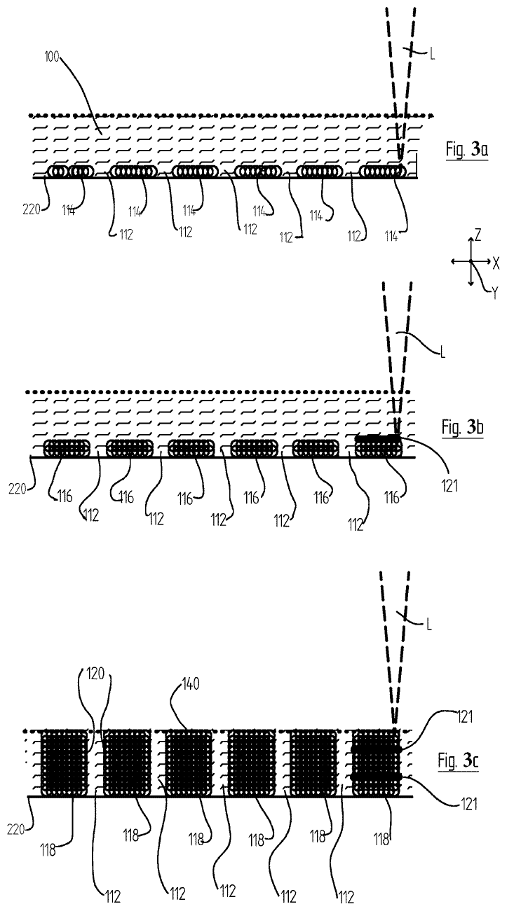

FIGS. 3a to 3c show a manufacturing technique for printing of a porous structure in accordance with various embodiments of the present invention.

Referring to FIG. 3a, there is shown schematically, an example of a production technique. Shown in section is a portion of a bath of liquid composition 100, including a silicon rubber substrate floor 220. The composition includes a mixture of at least: photo-activatable monomer molecules, photo activation initiator molecules and photo-activation quencher molecules as described below. In this illustration a linear series 114 of bits of the polymerised composition 100, have been formed using a photon beam L, focused at the a constant bit height in the Z axis. The focal point is aligned in a desired X and Y axis coordinate, where Z is up and down the page of the illustration, X is left and right of the illustration, and Y is into and out of the illustration. Such a beam forms overlapping polymerised bits 114 but control of the beam is used to leave unpolymerized ‘pores’ 112. This may be achieved, for example, by gating a beam and/or by using a pulsed photon beam.

The photon beam is then optically repositioned at an adjacent position in order to repeat the solidification of the next series 114 of bits. In the illustration, the beam focal point P has been scanned in X (from left to right) and periodically energised, to produce the series 114 of bits, but was not energised at the positions where pores 112 are intended to be located.

In FIG. 3b a second layer of polymerised bits has been produced, slightly overlapping the first layer shown in FIG. 3a, in this case by rescanning the focal point P in the same pattern as for FIG. 3a but raised in Z by a height of less than one bit size to overlap the first series of bits, but again allowing un-energised scanning of the beam over the pore areas 112. Such layer-by-layer polymerisation can then be repeated over and over to produce a porous structure of a desired thickness, and with almost any pore size and pore pattern.

FIG. 3c shows a final printed porous structure 140, formed by yet more layers of bits formed onto previous layers having unpolymerized pore areas 112. In practice those pore areas 112 are emptied of unpolymerized composition, e.g. by washing the printed porous structure 140 with solvent. For clarity, the bits are shown far larger than they are when formed in practice. Interstitial areas 118 formed between the edges 120 of the pore areas 112 are shown polymerised. However, it is within the ambit of this invention to leave at least a portion of those interstitial areas 118 unpolymerized, and once the pore areas 112 are washed out, a wide area final polymerisation can take place which polymerises the area 118 also. In various embodiments, the polymerised material is chosen to be readily sterilisable, from example by way of gamma irradiation.

For convenience the pore areas 112 have been shown as a simple vertical pore path, but it is just as simple to produce other shaped pore paths, for example a spiralling pore, a zig-zag pore, a pseudo random path, or the like, which in practice may be a better shape to retain or capture analytes of interest for example large molecules such as proteins, or cells, whilst allowing other matter to pass through the PPS. Such a circuitous path may be provided for depth filtering, for example.

The pore diameter may, for example, be less than 5 μm or larger, with typical pore path lengths (not necessarily PPS thickness) of 5, 10, 20, 50 or 100 times the pore diameter, for example. If the pore edge 120 only is to be polymerised, leaving the area 118′ still liquid, then for tall pores which have relatively small diameter, that then tall hollow structure may be relatively weak once the liquid in the pore area 112 has been washed out. It is then possible to strengthen those solidified edges 120 by polymerising a brace 121, joining, say, adjacent edges 120 of adjacent pore areas 112. Multiple braces between pores edges 120 could also be employed for increased strength and rigidity, for example cross braces 121 as are shown in FIGS. 3b and 3c.

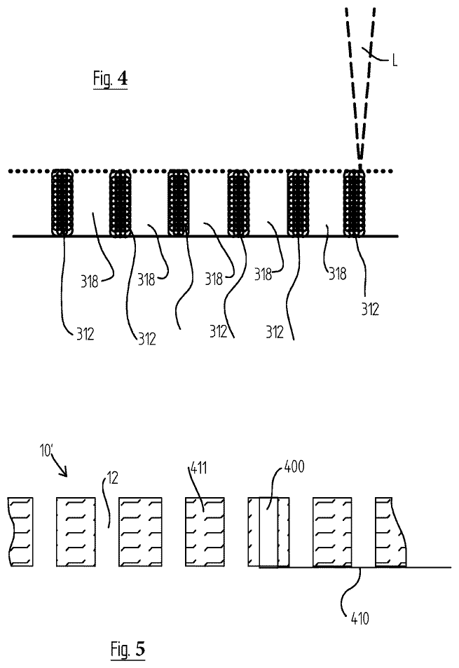

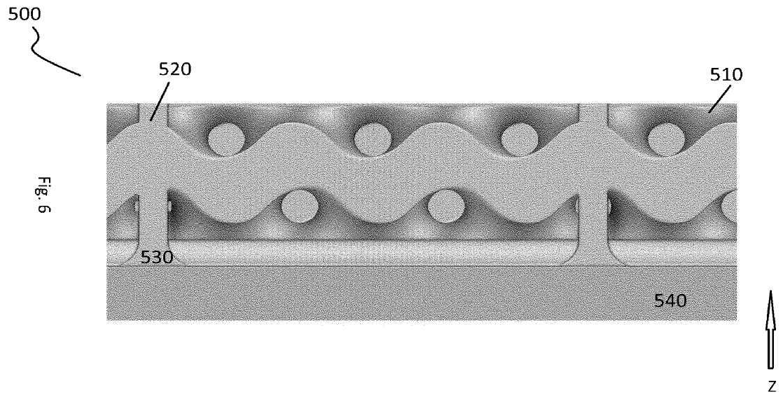

FIG. 4 shows a variant of the manufacturing technique shown in FIGS. 3a to 3c. In this embodiment, a male mould having artefacts 312 is formed by photo polymerisation using the same techniques as described above. The unpolymerized remainder 318 of the polymer is washed away, to leave a male mould, where the now voids 318 can be filled with a membrane forming material such as an in-filling thermosetting polymer. Once the in-filling polymer is set the moulds can be removed mechanically or by washing away with a suitable solvent, or by means of heat, to leave pores.

In various embodiments, a flowable composition 100 comprises a transparent photo-activatable acrylate monomer resin, with the addition of up to 3% of a photo activation initiator, such as an acylphosphine oxide such as 2,4,6-trimethylbenzoyldiphenylphosphine oxide molecules, or a benzophenone, a xanthone, or a quinone, or a combination of these molecules, and a photo-activation quencher such as tertiary amine molecules. The photon beam may be provided by an exciplex laser (also known as an excimer laser), e.g. having an output wavelength of about 800 nm with a pulse length of about 10 to 100 femtoseconds (fs), such as about 40 to 60 fs (for example about 50 fs may be preferred), optionally with a repetition rate of about 5 MHz.

Moreover, where the pores are of principal dimensional interest, the interspace between the pores may be filed-in with lower resolution, for example by using a higher energy photon beam where possible to photopolymerize a larger area more quickly, and thereby speed up the manufacturing process, or by the introduction of material by jetting, e.g. liquid thermoplastic introduction, which need not be the same material that surrounds the pore.

The energy required to induce local polymerisation may be provided by a focused photon beam at least at one focal point in the composition 100 by means of two-photon absorption polymerisations, i.e. where two or more photons are simultaneously absorbed by a photo activation initiator (photoinitiators) to create the active species that start polymerisation of a monomer resin. Under these conditions, multiphoton absorption occurs only in the region where intensity is at a maximum. That confines polymerization within the volume of the focused photon beam (known as a voxel). Slightly overlapping (for example 25% overlapping) bits of polymerised material may thus be produced. Quenching molecules may also provide fluorescence quenching to inhibit or halt the dendritic spread of polymer branches, which in turn can provide a more consolidated and defined polymerisation volume. The printed porous structure may further be revealed by washing away the unsolidified part of the resin using an organic solvent.

FIG. 5 shows a printed porous structure 10′ in accordance with an embodiment of the present invention. The printed porous structure 10′ comprises fibres 411, for example nano-fibres introduced into the composition bath 100 during manufacture, which do not unduly interfere with the formation of the pores described above. The finished printed porous structure 10′ thereby has improved mechanical strength. Additionally, or alternatively, a mesh or web of material (not shown) having a weave which is relatively course compared with the size and positioning of the pores could be immersed in the bath 100 prior to polymerisation, to achieve the same effect. Once the pores have been formed, the mesh etc. becomes incorporated into the printed porous structure 10′, again adding significant strength, and thereby allowing a greater trans-membrane pressure differential in use.

The substrate support 220 mentioned, is intended in the examples above to be a removable surface on which to form a porous structure. In addition, the substrate support 220 surface may optionally be employed to mount one or more micro-sensors 400 thereon and, if needed, electrically conductive paths 410 for communication and/or power to/from such sensors 400. These may, for example, be formed on a surface of the support 220 prior to the polymer bath being present, by 3D printing. Peeling off the support 220 from the finished porous structure or vice versa, will leave the sensors and any conductive tracks in place ready to be used on or in the finished porous structure.

In this case the micro-sensor 400 can be a capacitive gap sensor which measures transmembrane pressure differential, which can give an indication of the filtering performance of the PPS. Other sensors could be used, for example, other pressure sensors, flow sensors, conductivity sensors, pH sensors, osmolality sensors, chemical composition or concentration sensors etc, which can provide data in real time as filtration takes place, for example so as to measure porous structure performance.

In another example (not illustrated) the porous structure can be formed on a substrate, which substrate includes a light absorbance sensor and the porous structure includes an inlet and outlet to the sensor, such that the photo-adsorbent properties of the fluid passing through the porous structure can be monitored remotely. Thereby, the concentration of proteins or the like can be monitored. In yet another variant, the porous structure can be formed over microfluidic valves and over a pressure sensor, which can produce a signal for opening the valves, for example if the side-to-side pressure differential exceeds a predetermined amount. Other sensors could also be used, for example an electrical conductivity sensor where an interruption in an electrical path, for example if a porous structure were to rupture would signal porous structure failure, or temperature sensing, could be used. The use of more conventional, lower resolution material additive manufacturing to produce the additional sensors or other ancillary parts of a porous structure or filter device, e.g. a frame or other physical support, can be combined with the porous structure manufacturing methods described herein.

The embodiments shown provide a generally flat/planar porous structure, but porous structures can be useful in other shapes, for example tubular membranes which act as hollow fibres, in hollow fibre filtration.

The techniques described above can be used to provide asymmetric features in a single porous structure layer, and may even have multiple asymmetries in physical properties (for example wider, then narrower, then wider pores) and/or contoured surface characteristics to promote surface or depth filtering, such as a funnel pore opening or narrowed pore opening. For example, a gyroid lattice may be provided as a single volume version. However, a gyroid lattice may also be produced as a dual volume versions with two domains separated by a wall. This latter embodiment is particularly useful for providing heat exchangers, may also be used to facilitate cell exchange.

Chemical ligands or anchors for subsequent ligand attachment may be printed, allowing controlled placement and subsequent modifications of non-isotropic, asymmetric character for improved function and/or more efficiency use of (expensive) ligands.

Further, in an embodiment it is also possible to include light conduits or light guides. Such light guides may provide for a secondary polymerization step, for example inside a structure with poor transparency. Where the lights have terminal light diffusers or lenses, then light guided into the part-polymerised porous structure into the structure can be used to fully polymerise the porous structure.

Discrete sheet porous structure production has been described and illustrated, but it will be apparent that other techniques could be employed, for example a continuous manufacturing technique could be used, for example the finished porous structure could be peeled off its support 220, washed to produce the pores and then rolled onto a roll.

A MSA/TSA process may thus be used to produce a reduced size PPS in the millimetric or sub-millimetric scale (e.g. d=2.0 mm and h=0.07 mm) or a full size PPS (e.g. d=9.5 mm and h=0.07 mm), e.g. by applying a maximum of 5 iterations. In various embodiments, a highest applied printing resolution as follows can be applied: Slice distance in z-direction: 0.5 μm, Hatch distance in an x/y-direction: 0.5 μm. Parallel fabrication of a PPS (e.g. with the implementation of one DOE-diffractive optical element) may be provided and/or a line-to-line distance can 7.15 μm be used for certain embodiments.

Optionally a holder may also be provided for housing such PPS. This may also be produced using a MSA/TSA process. For example, a holder having a diameter d=13.0 mm or d=25.0 mm and a height of at least 30 μm may be provided.

Various other filters having one or more of the following characteristics can also be made:

| Unit cell structure | Woodpile | | Gyroid | |
|---|---|---|---|---|
| x-y total size | 13 | mm Ø | 13 | mm Ø |
| x-y porous structure size | 9 | mm Ø | 9 | mm Ø |
| z size (thickness) | at least 30 μm | | at least 30 μm | |
| Pore size | 5 | μm | 5 | μm |
| (spatial resolution between lines) | 3 | μm | 3 | μm |
| | 1 | μm | 1 | μm |
| | 500 | nm | 500 | nm |
| | 100 | nm | 100 | nm |

| Unit cell structure | Woodpile | | Gyroid | |
|---|---|---|---|---|
| x-y size | 300 | μm Ø | 300 | μm Ø |
| z size (thickness) | At least 100 μm | | At least 100 μm | |
| Pore size | 5 | μm | 5 | μm |
| (spatial resolution between lines) | 3 | μm | 3 | μm |
| | 1 | μm | 1 | μm |
| | 500 | nm | 500 | nm |
| | 100 | nm | 100 | nm |

| Unit cell structure | Woodpile | Gyroid |
|---|---|---|
| x-y total size | 25 mm Ø | 25 mm Ø |
| x-y porous structure size | 22 (down to 9) mm Ø | 22 (down to 9) mm Ø |
| z size (thickness) | 50 μm or minimum | 50 μm or minimum |
| | thickness allowing for | thickness allowing for |
| | ease of handling and | ease of handling and |
| | sample release from | sample release from |
| | substrate | substrate |

A PPS may be formed in one or more of the following photo-polymeric materials: acrylates, methacrylates, urethanes, PEG (poly-ethylene glycol)-based, PLA (poly-lactic acid)-based, protein-based (e.g. albumin, collagen, fibrinogen), and/or thiol-ene materials. These materials may be admixed to photo-initiators. Materials such as polyimide, polyethylene, polycarbonate and/or polypropylene may alternatively or additionally be micro drilled (e.g. using a laser or the like), and optionally may be about 10 μm thick. Micro drilling can be used to provide pores having an exit diameter of 2 μm±0.5 μm. In various embodiments, a pore entrance diameter of about 7 μm is provided. A processed area of the porous structure can be up to at least about 1 cm² in area with pore-pore distances (pitch) of about 10 μm or less. Such a printed porous structure may thus be used in microfiltration applications.

FIG. 6 shows a cross sectional view of a printed porous structure 500 fabricated using a multi-step absorption (MSA) process in accordance with an embodiment of the invention.

The printed porous structure (PPS) 500 comprises a support layer 520 that supports a filtration membrane 510. The support layer 520 and the filtration membrane 510 are integrally formed together upon a substrate 540. More specifically, support layer 520 and the filtration membrane 510 are not constructed as separate parts and subsequently physically joined together (e.g. by gluing, welding, thermal fusing, etc.) but are rather made together as part of the same fabrication process.

Both support layer 520 and the filtration membrane 510 are built up sequentially upon the substrate using the MSA process. The support layer 520 provides a scaffold that prevents any part of the filtration membrane 510 from coming into contact with the substrate 540 during formation of the PPS by providing a gap between the filtration membrane 510 and the substrate 540 in the Z-offset direction. The size of the gap required may be determined in accordance with the properties of the materials used, and the sizes, shapes and dimensions of structures of the support layer 520 and/or the filtration membrane 510.

In various embodiments, the support layer 520 and the filtration membrane 510 may be integrally formed from the same material. For example, an acrylate resin material may be used upon a glass substrate. In this embodiment, the support layer 520 preferably also includes widened substrate contact portions 530 that are initially formed adjacent to the substrate 540. Such a form helps prevent pore blocking of the lower or back side portion of the filtration membrane 510 formed proximal to the substrate 540. In various embodiments, the substrate contact portions 530 may be about twice the width at the contact part with the substrate 540 as compared to a top or main structural portion of the support layer 520.

The filtration membrane 510 is sequentially built up integrally with the support layer 520 to provide channels therein having a gyroid structure with a substantially triply periodic minimal surface (TPMS) form. For example, the TPMS may be of a diamond TPMS form. Once the final three-dimensional PPS 500 has been formed upon the substrate 540 it can then be removed therefrom (e.g. by way of physical and/or chemically aided peeling of the PPS 500 from the substrate 540).

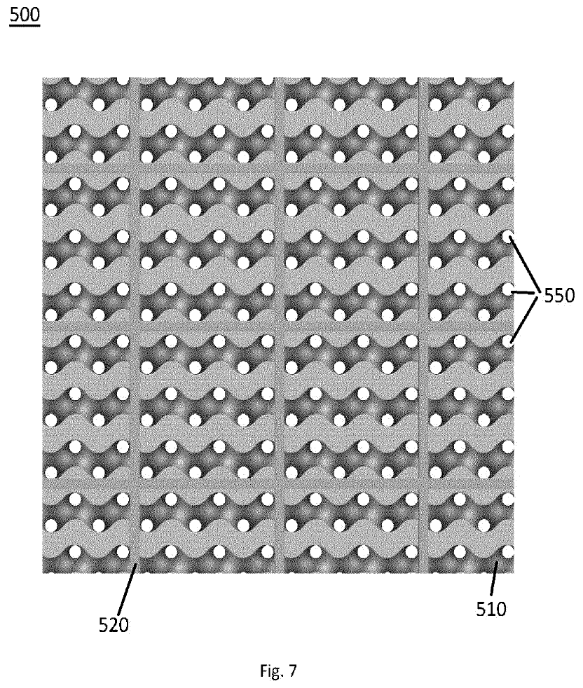

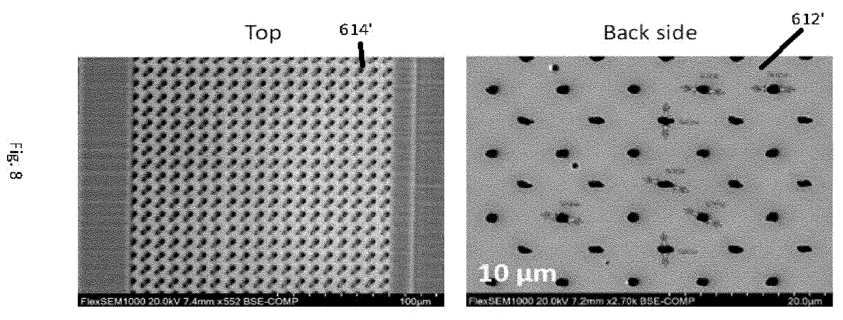

FIG. 7 shows a plan view of the embodiment of the printed porous structure (PPS) 500 of FIG. 6. As can be seen from FIG. 7, the scaffold provided by the support layer 520 is substantially grid shaped. In this instance, the grid forms a square/rectangular pattern with the areas within the grid effectively filled with filtration membrane 510 portions having respective pores/channels 550 therein. Whilst in this instance the grid pattern is square/rectangular, it would be understood that various alternative embodiments may be provided. For example, one or more hexagonal, octagonal etc. shaped pattern parts may be used as necessary. Moreover, irregular and/or mixed shape grid patterns may also be provided.

In this embodiment, a grid spacing of the scaffold is substantially equal to the size of a field of view of the objective lens that is used during the MSA process. This provides the advantage that stitch lines that can occur as an artefact of the MSA process, between sequentially manufactured adjacent areas, can be provided with re-enforcement by the scaffold. This both strengthens the stitch lines and also allows the PPS 500 to be more easily lifted from the substrate 540.

The grid may thus be provided by boundary walls that extend substantially in the Z-offset direction. Typical Z-offset (gap) values might be 2.5-10 μm, with typical grid spacing X-Y dimension values being 9-53 μm for a 1-3 μm pore size. Various dimensions affecting the necessary MSA process parameters needed for a given pore size were found to include: grid spacing; Z-offset and membrane size. Parameters found to be of lesser importance included: laser power; membrane thickness; membrane material type; pore size and mesh type (gyroid, woodpile, etc.).

FIG. 8 shows a top 614′ and back side 612′ view of a PPS made in accordance with a prior art MSA technique. The membrane was formed from an acrylate resin material on a glass substrate. The views 612′, 614′ were obtained using a scanning electron microscope (SEM). MSA PPS membranes were made for both 1 and 3 μm pore sizes.

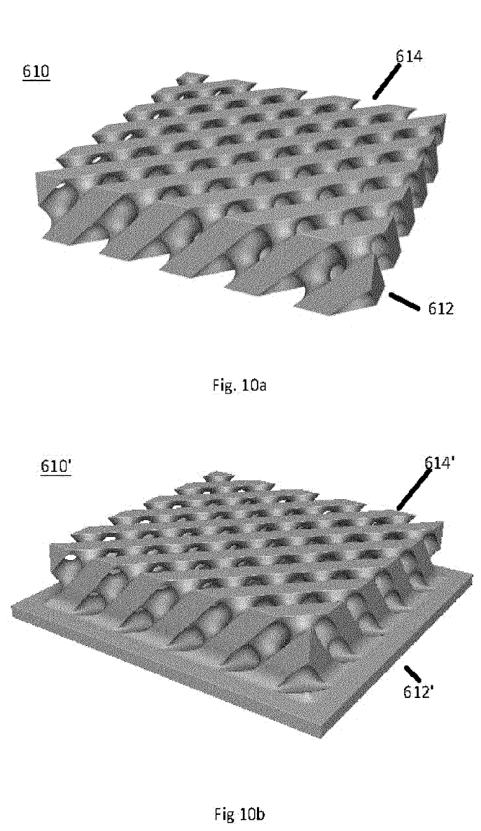

Top view 614′ shows that an acceptable upper membrane structure pattern having a gyroid channel form can be produced. However, back side view 612′ shows that the desired upper pattern is not repeated for the surface fabricated closest to the substrate used during the MSA process. The reasons for this are outlined further below, in relation to FIGS. 10a and 10b.

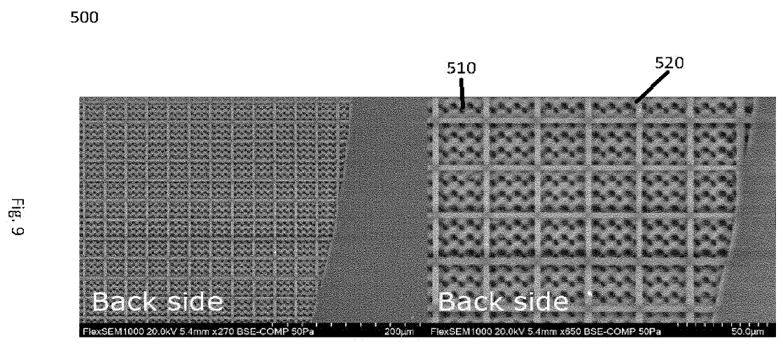

FIG. 9 shows a back side view of a PPS 500 made using an MSA process in accordance with an embodiment of the invention at two different magnifications. The views of PPS 500 were obtained using a scanning electron microscope (SEM). The PPS 500 was made using acrylate resin material formed on a glass substrate with a grid size of 26.5 by 26.5 μm. The membrane size was 13 mm (outer diameter) and 9 mm (inner diameter). The Z offset used was 10 μm and the filtration membrane portions had a thickness of 30 μm. The channel structure in the filtration membrane portions was of a gyroid TPMS form with a pore size of 3 μm.

Both views of FIG. 9 clearly show that an acceptable lower membrane structure pattern having clear, substantially ideal, gyroid shaped channels therein was produced.

FIGS. 10a and 10b show, respectively, an ideal gyroid structure 610 and a gyroid structure 610′ manufactured using a conventional MSA process.

FIG. 10a depicts an ideal gyroid structure 610 in which substantially constant cross-sectional gyroid-shaped passages are provided between an upper surface 614 and a lower surface 612. A gyroid structure (e.g. having a TPMS form) is useful as it provides good structural support, a tortuous path, and reduces chances of channel blocking by way of providing multiple through paths, etc. It may also be used to help substantially reduce or eliminate surface pressure variations across at least a portion of a filtration membrane 510.

In reality, however, when a conventional gyroid structure is manufactured on a substrate various flaws occur therein, as is shown in FIG. 10b. This is because at the interface between the printed mesh and the substate resin can smear out on the substrate, thereby closing the pores on the bottom side 612′. Depending on the geometry used, this may provide a narrow lines effect, or an almost completely clogged mesh. Additionally, the gyroid structure will often also have a fillet-like peripheral attachment to the substrate which also closes the pores on the substrate side.

Various embodiments produced using an MSA/TSA technique may thus be provided. Advantageously, the printing speed for these can also be increased compared to conventional methods without a loss of resolution. Additionally, such approaches also lead to a reduction of manufacturing costs due to: use of lower powerful light sources/beams, less use of printing materials/inks/photoinitiators etc. and provide for higher production volumes (printed units) for a comparable time frame. Furthermore, greater freedom in the choice of printed materials is enabled, such that the final composition of the ultimate printed product(s) is also greater in scope.

Various embodiments of the present invention may thus further provide self-standing (macrometric) structures that can be readily released after production. Such structures may provide improved substantially unrestricted flow path structures as compared to prior art MSA manufactured products that, for example, require grinding off/cutting off etc. of devices from a substrate after production. Moreover, the design of flow paths within such structures can be precisely controlled to provide a desired fluid flow structure (e.g. to provide a substantially constant fluid flow profile across the surface of a PPS or a PPS with desired localised fluid flow profiles therein).

Although numerous embodiments have been described and illustrated, it will be apparent to the skilled addressee that additions, omissions and modifications are possible to those embodiments without departing from the scope of the invention claimed.

1. A printed porous structure (PPS) fabricated using a multi-step absorption (MSA) process, said printed porous structure comprising a support layer that supports a filtration membrane, wherein said support layer and said filtration membrane are integrally formed.

2. The printed porous structure of claim 1, wherein the support layer provides a scaffold that prevents said filtration membrane from coming into contact with a substrate upon which the PPS is formed.

3. The printed porous structure of claim 2, wherein the scaffold is grid shaped.

4. The printed porous structure of claim 3, wherein a grid spacing of the scaffold is substantially equal to the size of a field of view of an objective lens used during the MSA process.

5. The printed porous structure of claim 1, wherein the MSA process uses one or more of: a multi-step, preferably a two-step absorption (TSA) method, an optically enabled method and/or projection-based manufacturing method.

6. The printed porous structure of claim 1, said filtration membrane comprising a woodpile, diamond lattice, body centred cubic (BCC) and/or a gyroid structure, optionally with a single focus, two foci, and/or three foci.

7. The printed porous structure of claim 6, wherein said filtration membrane comprises at least one gyroid structure portion.

8. The printed porous structure of claim 7, wherein said at least one gyroid structure portion has a TPMS structure.

9. The printed porous structure of claim 1, comprising substantially similar sized pores therein.

10. The printed porous structure of claim 1, wherein pores therein have a size of about: 15 μm, 10 μm, 5 μm, 3 μm, 1 μm, 500 nm and/or 100 nm and any intermediate sizes therein.

11. The printed porous structure of claim 1, having pore-pore distances (pitch) of about 10 μm or less therein.

12. The printed porous structure of claim 1, having a surface diameter (Ø) of about 13 mm or about 25 mm or less therein.

13. The printed porous structure of claim 1, having a thickness (z) of: about 5, 10 or 20 μm; at least about 30 μm; at least about 50 μm or at least about 100 μm.

14. The printed porous structure of claim 1, further comprising at least one region that is substantially devoid of any pores.

15. The printed porous structure of claim 1, further comprising at least one processed area at least about 0.5 mm² and up to at least about: 1 mm², 10 mm², 1 cm² or 4-5 cm².

16. The printed porous structure of claim 1, wherein said material comprises: polyimide, polyethylene, polycarbonate, polypropylene, one or more acrylate(s), methacrylate(s), urethane(s), PEG (poly-ethylene glycol)-based, PLA (poly-lactic acid)-based, protein-based (e.g. albumin, collagen, fibrinogen) or thiol-ene materials, optionally in the form of low-viscosity fluids, high-viscosity fluids or solids.

17. The printed porous structure of claim 16, wherein the material is admixed to at least one photo-initiator, optionally including water-soluble and possible doping materials, such as metals, ceramics, nanoparticles or nanotubes, hydrogels and/or shape memory polymers.

18. The printed porous structure (PPS) of claim 1, wherein said support layer and said filtration membrane are integrally formed from the same material.

19. A filter arrangement comprising the printed porous structure (PPS) of claim 1, and a holder therefor, said holder optionally also being integrally formed with said PPS.

20. A method for the production of the printed porous structure of claim 1, comprising the following steps:
a) providing a photo-activatable composition; and
b) photonically activating said photo-activatable composition to define said printed porous structure.

21. The method of claim 20, wherein the photo-activatable composition is a flowable photo-activatable composition.

22. The method of claim 20, wherein photonically activating said photo-activatable composition to define said printed porous structure comprises sequentially activating said photo-activatable composition at a plurality of different positions so as to form said printed porous structure.

23. The method of claim 22, comprising:
i) providing photons to at least one focal point in the photo-activatable composition of sufficient energy to locally polymerise the composition;
ii) moving the or each focal point relative to previously polymerised composition in a continuous or stepwise predetermined manner to a multiplicity of further positions; and
iii) repeating steps i) and ii) such that a three-dimensional matrix of the composition is polymerised leaving unpolymerized areas corresponding to printed porous structure pores.

24. The method of claim 20, wherein the step of photonically activating said composition to define said printed porous structure comprises illuminating the photo-activatable composition with one or more of: infrared, near-infrared, visible and/or ultraviolet photons.

25. The method of 24, wherein at least two photons photonically activate said photo-activatable composition.

26. The method of claim 20, wherein photons are provided by one or more of: a continuous beam laser, a pulsed beam laser, a light emitting diode (LED), a lamp, a discharge tube and a photon emitter.

27. The method of claim 20, further comprising the step(s) of: i) removing unpolymerized composition to leave open pores in the printed porous structure; and/or ii) producing the printed porous structure or filter arrangement on a substrate and removing the printed porous structure or filter arrangement from the substrate once it has been produced.

28. The method of claim 20, comprising using one or more of: a multi-beam, interferometric, projection-based and/or holographic technique to photonically activate said photo-activatable composition.

29. An apparatus for producing a printed porous structure, the apparatus being operable to perform the method of claim 20.
